(19) United States
(12) Patent Application Publication
(10) Pub. No.: US 2026/0029825 A1
(43) Pub. Date: Jan. 29, 2026

(54) Ergonomic based Reconfiguration of Virtual Input Device

(71) Applicant: Telefonaktiebolaget LM Ericsson (publ), Stockholm (SE)

(72) Inventors: Andreas Kristensson, Södra Sandby (SE); Peter Ökvist, Luleå (SE); Tommy Arngren, Södra Sunderbyn (SE)

(21) Appl. No.: 18/703,934

(22) PCT Filed: Oct. 29, 2021
(86) PCT No.: PCT/EP2021/080160

§ 371 Date: Apr. 23, 2024

(51) Int. Cl. G06F 1/16; G06F 3/01

(52) U.S. Cl. CPC G06F 1/1664; G06F 1/1673; G06F 3/011

(57) ABSTRACT

There is provided mechanisms for ergonomic based reconfiguration of a virtual input device. A method is performed by a control device. The method comprises obtaining information of posture and/or movement of a user from a sensor whilst the user is interacting with the virtual input device in a virtual environment. The method comprises determining whether or not the posture and/or movement of the user satisfies an ergonomic criterion by comparing the posture and/or movement of the user to reference ergonomic data. The method comprises reconfiguring, when the posture and/or movement of the user fails to satisfy the ergonomic criterion, at least one setting of the virtual input device.

### TECHNICAL FIELD

Embodiments presented herein relate to a control device, a method, a computer program, and a computer program product for ergonomic based reconfiguration of a virtual input device.

### BACKGROUND

Virtual input devices, such as optical virtual keyboards allow input of characters in a virtual reality (VR) or augmented reality (AR) environment without the need for physical keys. The human interaction with the virtual keyboard occurs mostly via a touchscreen interface, but can also take place in a different form in a VR or AR environment. In this respect, optical virtual keyboards are examples of user interfaces in VR or AR configured to optically detect and analyze human hand and finger movements and interpret them as operations on a physically non-existent input device, such as a surface with painted or projected keys. In this way optical virtual keyboards can emulate unlimited types of manually operated input devices (such as a mouse, keyboard, and other devices). Furthermore, another example of an optical virtual keyboard is a projection keyboard which is a form of computer input device whereby the image of a virtual keyboard is projected onto a surface. When a user touches the surface covered by an image of a key, the input device records the corresponding keystroke. Moreover, some optical virtual keyboards are based on combinations of laser and tactile sensors where finger-on-projected-area in combination with micro-vibration detection are considered. For example, a projected finger tap detected simultaneously with a tap-rendered vibration is indicative as a key stroke. Mechanical input units can thereby be replaced by such virtual input devices, potentially optimized for a specific application and for the user's physiology, maintaining speed, simplicity and unambiguity of manual data input.

However, it could be cumbersome for the user to find the correct setting of the virtual input device so that the virtual input device indeed is optimized for a specific application and for the user's physiology. If it is difficult for the user to find such correct settings, the user might either avoid making any settings or even avoid using the virtual input device.

The user of virtual input devices can thus still result in ergonomic problems for the user. Hence, there is still a need for virtual input devices with improved ergonomics.

### SUMMARY

An object of the embodiments described herein is to address the above issues and to provide techniques that improve the ergonomics for the user during interaction with virtual input devices.

According to a first aspect, the object is addressed by providing a control device for ergonomic based reconfiguration of a virtual input device. The control device comprises processing circuitry. The processing circuitry is configured to cause the control device to obtain information of posture and/or movement of a user from a sensor while the user is interacting with the virtual input device in a virtual environment. The processing circuitry is configured to cause the control device to determine whether or not the posture and/or movement of the user satisfies an ergonomic criterion by comparing the posture and/or movement of the user to reference ergonomic data. The processing circuitry is configured to cause the control device to reconfigure at least one setting of the virtual input device when the posture and/or movement of the user fails to satisfy the ergonomic criterion. The at least one setting is reconfigured as a function of the posture and/or movement of the user and the reference ergonomic data to suggest the user to change the posture and/or movement to be closer to satisfying the ergonomic criterion.

According to a second aspect, the object is addressed by providing a method for ergonomic based reconfiguration of a virtual input device. The method is performed by a control device. The method comprises obtaining information about the posture and/or movement of a user from a sensor while the user is interacting with the virtual input device in a virtual environment. The method comprises determining whether or not the posture and/or movement of the user satisfies an ergonomic criterion by comparing the posture and/or movement of the user to reference ergonomic data. The method comprises reconfiguring at least one setting of the virtual input device when the posture and/or movement of the user fails to satisfy the ergonomic criterion. The at least one setting is reconfigured as a function of the posture and/or movement of the user and the reference ergonomic data to suggest to the user to change the posture and/or movement to be closer to satisfying the ergonomic criterion.

According to a third aspect, the object is addressed by providing a computer program for ergonomic based reconfiguration of a virtual input device, the computer program comprising computer program code which when run on a control device, causes the control device to perform a method according to the second aspect.

According to a fourth aspect the object is addressed by providing a computer program product comprising a computer program according to the fourth aspect and a computer readable storage medium on which the computer program is stored. The computer readable storage medium could be a non-transitory computer readable storage medium.

According to a fourth aspect the object is addressed by providing a system comprising the control device according to the first aspect, and a user interface device. The user interface device comprises a projection module for making the virtual input device visible on a surface. The user interface device further comprises the sensor for sensing user interaction of the user with the virtual input device.

Advantageously, these aspects enable the shape, size, form and/or physical placement of virtual input devices to be adapted to the individual physical characteristics of the user, In this fashion, the user is urged to assume a more ergonomic position in relation to the virtual input device, thus avoiding, reducing, or at least mitigating ergonomic problems caused by interacting with the virtual input device

In some embodiments, the posture and/or movement of the user is represented by a user model defining a digital twin of the user, and the digital twin is compared to the reference ergonomic data when determining whether or not the posture and/or movement of the user satisfies the ergonomic criterion.

In some embodiments, the digital twin represents any of: arms, hands, legs, feet, neck, head and torso of the user, or any combination thereof, with relative dimensions extracted from a digital representation of the user.

In some embodiments, the threshold value is dependent on relative dimensions of arms, hands, head and/or torso of the user as derived from a digital representation of the user.

In some embodiments, the reference ergonomic data represents postures and/or movements to be used by the user, wherein the posture and/or movement of the user fails to satisfy the ergonomic criterion when the posture and/or movement of the user deviate more than a first threshold value from the reference ergonomic data, and whereby the user is suggested to change the posture and/or movement to be closer to the reference ergonomic data.

In some embodiments, the reference ergonomic data represents postures and/or movements to be avoided by the user, wherein the posture and/or movement of the user fails to satisfy the ergonomic criterion when the posture and/or movement of the user deviate less than a second threshold value from the reference ergonomic data, and whereby the user is suggested to change the posture and/or movement to be further away from the reference ergonomic data.

In some embodiments, the processing circuitry further is configured to cause the control device to:
retrieve historical data representing previous postures and/or movements of the user, and wherein determining whether or not the posture and/or movement of the user satisfies the ergonomic criterion further is a function of the historical data.

In some embodiments, the processing circuitry further is configured to cause the control device to:
aggregate tracked posture and/or movement of the user over time; and
construct a user model from the tracked posture and/or movement of the user.

In some embodiments, the posture and/or movement of the user is tracked by at least one sensor configured to record sensor data representing a digital representation of the user, and wherein the digital representation of the user is analysed to track the posture and/or movement of the user in relation to the user input device in the virtual environment.

In some embodiments, the digital representation of the user pertains to at least one of hand position and/or movement of the user, arm position and/or movement of the user, head position and/or movement of the user, neck position and/or movement of the user, and torso position and/or movement of the user.

In some embodiments, reconfiguring the at least one setting of the virtual input device is constrained by at least one property of a physical environment in which the virtual input device is deployed.

In some embodiments, the constraints are derived by the control device from information received by the control device of the physical environment.

In some embodiments, the at least one setting pertains to layout of buttons and/or keys on the virtual input device, and the at least one setting is reconfigured by the layout of the buttons and/or keys being changed on the virtual input device.

In some embodiments, the at least one setting pertains to size and/or shape of buttons and/or keys on the virtual input device, and the at least one setting is reconfigured by the size and/or shape of the buttons and/or keys being changed on the virtual input device.

In some embodiments, the at least one setting pertains to size and/or shape of the virtual input device, and the at least one setting is reconfigured by the size and/or shape of the virtual input device being changed.

In some embodiments, the at least one setting pertains to a spatial location of the virtual input device, and the at least one setting is reconfigured by the spatial location of the virtual input device being changed.

In some embodiments, the at least one setting of the virtual input device is step wise reconfigured from a start setting to a final setting via at least one intermediate setting.

In some embodiments, the virtual input device is any of: a virtual keyboard, a virtual computer mouse, a virtual remote controller, a virtual gaming controller.

In some embodiments, the virtual environment is an extended reality (XR) virtual environment.

In some embodiments, the virtual environment is either an augmented reality (AR) virtual environment, a virtual reality (VR) virtual environment, or a mixed reality (MR) virtual environment.

In some embodiments, the control device is part of or integrated with a communication device.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

Moreover, the term “comprising” followed by statements of technical features or method steps should be understood as not excluding the presence of other technical features of method steps not stated in the appended claims.

### BRIEF DESCRIPTION OF THE DRAWINGS

The inventive concept is now described, by way of example, with reference to the accompanying drawings, in which:

FIG. 1 is a schematic diagram illustrating a system according to embodiments;

FIG. 2 schematically illustrates users interacting with a user interface device according to embodiments;

FIG. 3 schematically illustrates a user interface device projecting a virtual input device according to embodiments;

FIGS. 4 and 5 are flowcharts of methods according to embodiments;

FIG. 6 is a schematic diagram showing functional units of a control device according to an embodiment;

FIG. 7 is a schematic diagram showing functional modules of a control device according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

FIG. 1 is a schematic diagram of a system 100. The system 100 comprises a user interface device 110 and a control device 600. The user interface device 110 and the control device 600 are operatively connected to each other.

In some implementations, the control device 600 is part of, or integrated with, the user interface device 110. In some implementations, the control device 600 is part of or integrated with a communication device, such as a mobile phone, tablet, computer, or the like.

The user interface device 110 comprises a projection module 114 for making a virtual input device 120 visible on a surface. In FIG. 1 the virtual input device 120 is schematically illustrated as a virtual keyboard. In other non-limiting examples, the virtual input device 120 is any of: a virtual computer mouse, a virtual remote controller, a virtual gaming controller.

The user interface device 110 further comprises a sensor 112 for sensing user interaction of a user with the virtual input device 120 at coordinates along the surface. The sensor 112 is further configured to track posture and/or movement of the user. The posture and/or movement of the user can be tracked by at least one sensor 112 configured to record sensor data representing a digital representation of the user. The digital representation of the user 210a, 210b can be analysed to track the posture and/or movement of the user in relation to the user input device 120 in the virtual environment. In some non-limiting examples, the digital representation of the user 210a, 210b pertains to at least one of: hand position and/or movement of the user 210a, 210b, arm position and/or movement of the user 210a, 210b, head position and/or movement of the user 210a, 210b, neck position and/or movement of the user 210a, 210b, and torso position and/or movement of the user 210a, 210b. The sensor 112 could be a radar module, a lidar module, a camera module, or the like. In some examples, the sensor 112 is an inertial measurement unit (IMU) and is provided on gloves worn by the user. Hence, the functionality of the user interface device 110 might be split between at least two physical devices. Further, also combinations of different types of sensors 112 are possible.

In FIG. 1 the user is schematically represented by two hands 130a, 130b. Software converts the coordinates to identify actions or characters put in by the user. The virtual input device 120 is part of a virtual environment. There could be different types of virtual environments. In some non-limiting examples, the virtual environment is an extended reality (XR) virtual environment. In further non-limiting examples, the virtual environment is either an augmented reality (AR) virtual environment, a virtual reality (VR), virtual environment, or a mixed reality (MR) virtual environment. Hence, although the user interface device 110 in FIG. 1 is illustrated as a stand-alone device, the user interface device 110 could be part of a headset (such as a VR headset), or wearable computer glasses (such as AR glasses, or smart glasses).

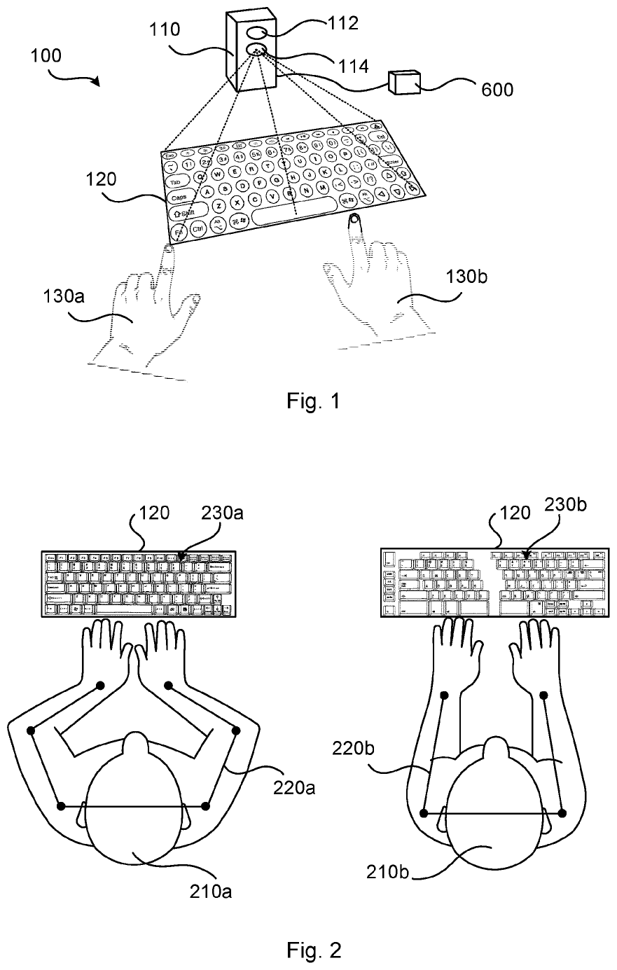

As noted above there is still a need for virtual input devices 120 with improved ergonomics. To further illustrate this, reference is made to FIG. 2. FIG. 2 schematically illustrates a first user 120a interacting with a user interface device 120 in terms of a virtual keyboard having a first layout 230a and a second user 120b interacting with a user interface device 120 in terms of a virtual keyboard having a second layout 230b. The first user 210a is modelled according to a first user model 220a and the second user 210b is modelled according to a second user model 220b. It is assumed that the first user 210a and the second user 120b are identical to each other. If compared to a standard ergonomic model, where the user's arms and hands together should follow a straight line and the imaginary line between the shoulders should be close to 90 degrees in relation to that straight line, the first layout 230a causes stress on the shoulders and wrists of the first user 120a. The second layout 230b is much closer to the standard ergonomic model. It can therefore be concluded from the first user model 220a and the second user model 220b that the second layout 230b provides a more ergonomically sound virtual keyboard for the user than the first layout 230a. Interacting with a user interface device 120 in terms of a virtual keyboard having the first layout 230a could thus result in ergonomic problems for the first user 210a.

The embodiments disclosed herein therefore relate to mechanisms for ergonomic based reconfiguration of a virtual input device. In order to obtain such mechanisms there is provided a control device, a method performed by the control device, a computer program product comprising code, for example in the form of a computer program, that when run on a control device, causes the control device to perform the method.

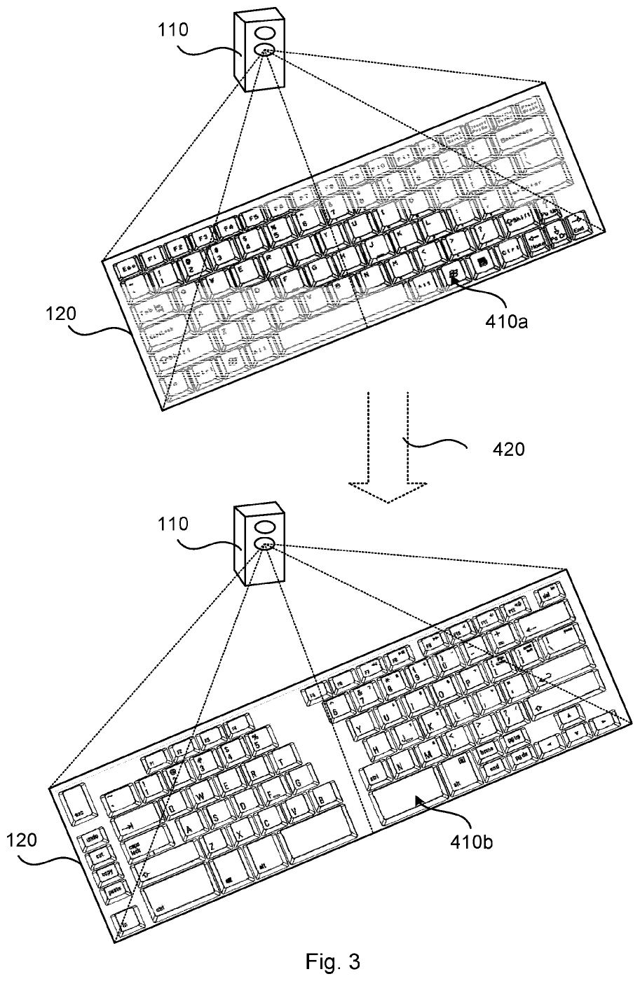

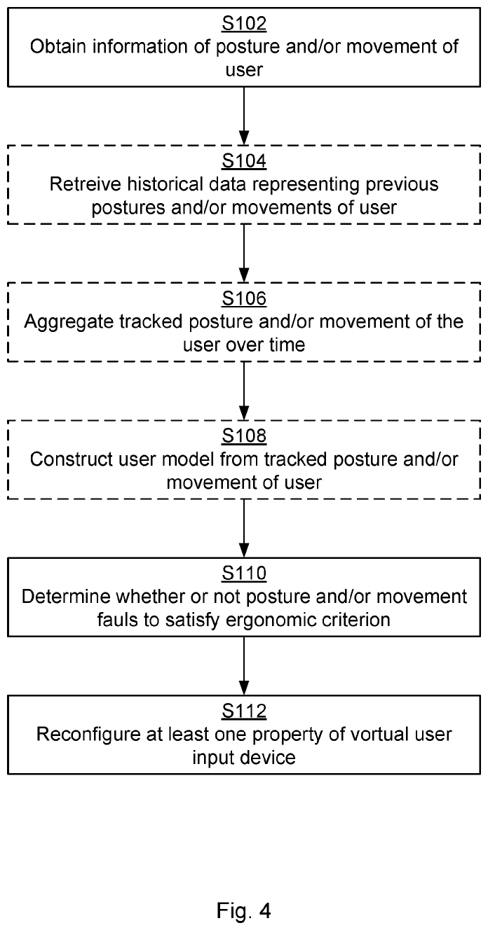

Parallel reference will next be made to FIG. 3 and FIG. 4 for disclosure of ergonomic based reconfiguration of a virtual input device 120.

FIG. 3 schematically illustrates a user interface device 110 projecting a virtual input device 120 in the form of a virtual keyboard that is changeable between a first setting 410a, e.g., a default keyboard configuration and a second setting 410b, which would correspond to a more ergonomically advantageous keyboard position and layout for the present user 210a, 210b. A change between the first setting 410a and the second setting 410b is schematically illustrated by arrow 420. As will be further disclosed below, control device 600 is configured to adaptively change the virtual input device 120 between the first setting 410a and the second setting 410b based on a comparison of the current posture and/or movement of the user 210a, 210b and reference ergonomic data.

FIG. 4 is a flowchart illustrating embodiments of methods for ergonomic based reconfiguration of a virtual input device 120. The methods are performed by the control device 600. The methods are advantageously provided as computer programs 320.
S102: The control device 600 obtains information of posture and/or movement of a user 210a, 210b from a sensor 112 whilst the user 210a, 210b is interacting with the virtual input device 120 in a virtual environment.
S110: The control device 600 determines whether or not the posture and/or movement of the user 210a, 210b satisfies an ergonomic criterion by comparing the posture and/or movement of the user 210a, 210b to reference ergonomic data.
S112: The control device 600 reconfigures, when the posture and/or movement of the user 210a, 210b fails to satisfy the ergonomic criterion, at least one setting 410a, 410b of the virtual input device 120.

The at least one setting 410a, 410b suggests how, in terms of the posture and/or movement, the user 210a, 210b is to interact with the virtual input device 120 in the virtual environment. Examples of settings will be provided below. The at least one setting 410a, 410b is reconfigured as a function of the posture and/or movement of the user 210a, 210b and the reference ergonomic data.

Reconfiguring the at least one setting 410a, 410b of the virtual input device 120 suggests to the user 210a, 210b to change the posture and/or movement to be closer to satisfying the ergonomic criterion.

With reference back to FIG. 2, by tracking posture and/or movement of a user 210a, 210b whilst the user 210a, 210b is interacting with the virtual input device 120 in a virtual environment the control device 600 can adaptively change the virtual keyboard between the first layout 230a and the second layout 230b depending on the posture and/or movement of the user 210a, 210b, thereby helping the user 210a, 210b to avoid ergonomic problems, or at least creating less ergonomic problems for the user 210a, 210b.

Embodiments relating to further details of ergonomic based reconfiguration of a virtual input device 120 as performed by the control device 600 will now be disclosed.

In some aspects, the posture and/or movement of the user 210a, 210b is tracked by means of a user model 220a, 220b. In particular, in some embodiments, the posture and/or movement of the user 210a, 210b is represented by a user model 220a, 220b stored as a digital twin of the user 210a, 210b. The digital twin is then compared to the reference ergonomic data when determining whether or not the posture and/or movement of the user 210a, 210b satisfies the ergonomic criterion. A holistic model, defined by the digital twin, of the user 210a, 210b can thus be created, where each limb of the user 210a, 210b can be digitally recreated so that the control device 600 can calculate a representation of the current user pose and limb placement and hand, arm, and finger placement and movement in relation to each other. This allows the control device 600 to not only get a snapshot of the current ergonomic situation but also to build an understanding of the ergonomic situation over time.

In some aspects, the relative length of scale of the limbs of the user 210a, 210b is considered to avoid using a setting 410a, 410b of the virtual input device 120 that results in a poor ergonomic position for the individual user 210a, 210b. Particularly, in some non-limiting examples, the digital twin represents any of: arms, hands, legs, feet, neck, head and torso of the user 210a, 210b, or any combination thereof, with relative dimensions extracted from a digital representation of the user 210a, 210b. Similarly, in some non-limiting examples, the threshold value is dependent on relative dimensions of arms, hands, head and/or torso of the user 210a, 210b as derived from a digital representation of the user 210a, 210b.

In some aspects, the user model 220a, 220b is compared with existing predefined models of poses and limb placements that are ergonomically sound and preferable, and/or a set of identified explicitly poor constellations that should be avoided (such as acute limb angles, short distance to torso causing forward head posture/nerd neck, etc.). If a deviation from existing predefined models is detected an ergonomic issue is deemed to be identified, thus deciding whether or not the posture and/or movement of the user 210a, 210b satisfies the ergonomic criterion.

In some aspects, the user model 220a, 220b is compared to predefined models of postures and/or movements that are ergonomically sound and should be used. In particular, in some embodiments, the reference ergonomic data represents postures and/or movements to be used by the user 210a, 210b. The posture and/or movement of the user 210a, 210b then fails to satisfy the ergonomic criterion when the posture and/or movement of the user 210a, 210b deviate more than a first threshold value from the reference ergonomic data. The user 210a, 210b is thereby suggested to change the posture and/or movement to be closer to the reference ergonomic data.

In some aspects, the user model 220a, 220b is compared to predefined models of postures and/or movements that are ergonomically poor and should be avoided. In particular, in some embodiments, the reference ergonomic data represents postures and/or movements to be avoided by the user 210a, 210b. The posture and/or movement of the user 210a, 210b then fails to satisfy the ergonomic criterion when the posture and/or movement of the user 210a, 210b deviate less than a second threshold value from the reference ergonomic data. The user 210a, 210b is thereby suggested to change the posture and/or movement to be further away from the reference ergonomic data.

In some aspects, both spatial and temporal historical data can be used as input; e.g. it might for the user be ok to use a less optimal pose and limb placement for less than 5 minutes if it is not repeated in a pattern over time. In particular, in some embodiments, the control device 600 is configured to perform (optional) step S104:
S104: The control device 600 retrieves historical data representing previous postures and/or movements of the user 210a, 210b. Determining whether or not the posture and/or movement of the user 210a, 210b satisfies the ergonomic criterion further is a function of the historical data.

In some aspects, the control device 600 aggregates position and/or movement over time to build an understanding of the ergonomic situation over time. In particular, in some embodiments, the control device 600 is configured to perform (optional) step S106 and step S108:
S106: The control device 600 aggregates tracked posture and/or movement of the user 210a, 210b over time.
S108: The control device 600 constructs a user model 220a, 220b from the tracked posture and/or movement of the user 210a, 210b.

Relative positioning of respective head, torso, arms, hands and fingers, etc. might thereby be aggregated over time for the control device 600 to not only detect intermittently used poor ergonomic constellations, but also to consider long-term (aggregated) use thereof.

In some aspects, the reconfiguring is constrained by the physical environment in which the virtual input device 120 is deployed. For example, if the virtual input device 120 is deployed in a confined physical space, such as when the user is travelling using a public means of transportation, there might be less available space than if the virtual input device 120 is deployed in a private environment, or a work environment, especially designed for interaction with the virtual input device 120. In particular, in some embodiments, the virtual input device 120 is deployed in a physical environment, and reconfiguring the at least one setting 410a, 410b of the virtual input device 120 is constrained by at least one property of the physical environment. In particular, in some embodiments, the constraints are derived by the control device 600 from information received by the control device 600 of the physical environment. The at least one property of the physical environment might be sensed by the sensor 112. For example, the sensor 112 might be configured to measure, or estimate, proximity to objects in the physical environment and provide measurements, or estimates, as information to the control device 600.

In some aspects, the virtual input device 120 can be changed in terms of layout, size, shape, form, or location. This is regardless of whether the virtual input device 120 is a virtual keyboard, a virtual computer mouse, a virtual remote controller, or a virtual gaming controller. The virtual input device 120 can thus be reconfigured to alternate the physical locality of the virtual input device 120 in relation to other input device used by the user within a determined sound position range to help the user avoid static loads of joints, neck, etc.

According to a first example, the change pertains to size or shape of individual buttons and/or keys of the virtual input device 120. In particular, in some embodiments, the at least one setting 410a, 410b pertains to size and/or shape of buttons and/or keys on the virtual input device 120. The at least one setting 410a, 410b is then reconfigured by the size and/or shape of the buttons and/or keys being changed on the virtual input device 120.

According to a second example, the change pertains to overall size or shape of the virtual input device 120. In particular, in some embodiments, the at least one setting 410a, 410b pertains to size and/or shape of the virtual input device 120. The at least one setting 410a, 410b is then reconfigured by the size and/or shape of the virtual input device 120 being changed.

According to a third example, the change pertains to spatial location of the virtual input device 120. In particular, in some embodiments, the at least one setting 410a, 410b pertains to spatial location of the virtual input device 120. The at least one setting 410a, 410b is then reconfigured by the spatial location of the virtual input device 120 being changed.

In some aspects, the virtual input device 120 is stepwise reconfigured. In particular, in some embodiments, the at least one setting 410a, 410b of the virtual input device 120 is stepwise reconfigured from an initial setting to a final setting via at least one intermediate setting. The reconfiguration could thus be performed gradually over a period of time so as to not disturb the user during an input session. This means e.g., that a virtual keyboard could slowly and gradually shapeshift from one keyboard layout to another keyboard layout.

In some aspects, upon having determined that the posture and/or movement of the user 210a, 210b fails to satisfy the ergonomic criterion, but before reconfiguring the at least one setting 410a, 410b of the virtual input device 120, the control device 600 may provide an indication to the user 210a, 210b to make the user 210a, 210b aware that the posture and/or movement of the user 210a, 210b fails to satisfy the ergonomic criterion. Possibly, the indication is accompanied by instructions in order to give the user 210a, 210b a chance to cancel or approve a proposed solution. Approving a proposed solution could be allowed to speed up shapeshifting of the virtual input device 120 as well and even directly go to, e.g., a new keyboard layout without any intermediate keyboard layout.

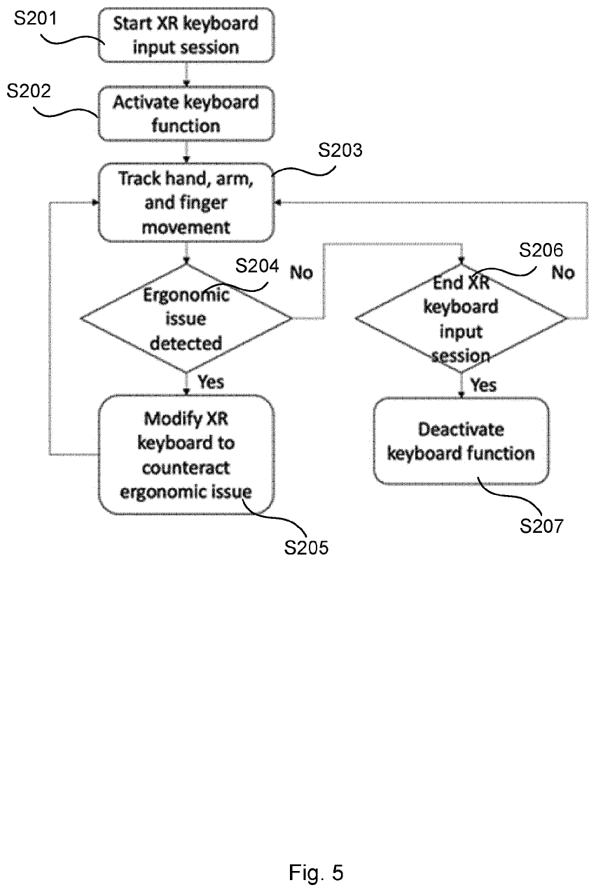

FIG. 5 is a flowchart of a method for ergonomic based reconfiguration of a virtual input device 120 as performed by the control device 600 according to at least some of the embodiments, aspects, and examples disclosed herein.
S201: The control device 600 detects that the user intends to start a session with the virtual input device 120.
S202: The control device 600 instructs the user interface device 110 to make the virtual input device 120 visible.
S203: The control device 600 tracks posture and/or movement of a user 210a, 210b while the user 210a, 210b is interacting with the virtual input device 120.
S204: The control device 600 determines whether or not the posture and/or movement of the user 210a, 210b satisfies an ergonomic criterion by comparing the posture and/or movement of the user 210a, 210b to reference ergonomic data
S205: The posture and/or movement of the user 210a, 210b fails to satisfy the ergonomic criterion. The control device 600 reconfigures at least one setting 410a, 410b of the virtual input device.
S206: The control device 600 detects that the user no longer interacts with the virtual input device 120 and determines to end the session started in S201.
S207: The control device 600 instructs the user interface device 110 to stop making the virtual input device 120 visible.

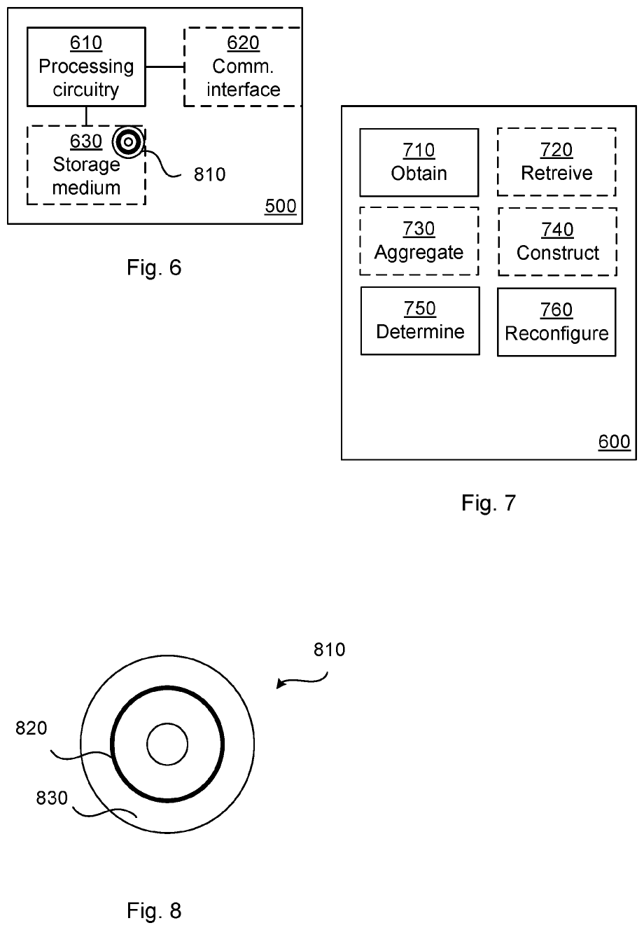

FIG. 6 schematically illustrates, in terms of a number of functional units, the components of a control device 600 according to an embodiment. Processing circuitry 610 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 630. The processing circuitry 610 may further be provided as at least one application specific integrated circuit (ASIC), or field programmable gate array (FPGA).

Particularly, the processing circuitry 610 is configured to cause the control device 600 to perform a set of operations, or steps, as disclosed above. For example, the storage medium 630 may store the set of operations, and the processing circuitry 610 may be configured to retrieve the set of operations from the storage medium 630 to cause the control device 600 to perform the set of operations. The set of operations may be provided as a set of executable instructions.

Thus the processing circuitry 610 is thereby arranged to execute the methods disclosed herein. The storage medium 630 may also comprise persistent storage, which, for example, can be any single one or combination of magnetic memory, optical memory, solid state memory or even remotely located memory. The control device 600 may further comprise a communications interface 620 at least configured for communications with other entities, functions, nodes, and devices. As such, the communications interface 620 may comprise one or more transmitters and receivers, comprising analogue and digital components. The processing circuitry 610 controls the general operation of the control device 600 e.g. by sending data and control signals to the communications interface 620 and the storage medium 630, by receiving data and reports from the communications interface 620, and by retrieving data and instructions from the storage medium 630. Other components, as well as the related functionality, of the control device 600 are omitted in order not to obscure the concepts presented herein.

FIG. 7 schematically illustrates, in terms of a number of functional modules, the components of a control device 600 according to an embodiment. The control device 600 of FIG. 7 comprises a number of functional modules; an obtain module 710 configured to perform step S102, a determine module 750 configured to perform step S110, and a reconfigure module 760 configured to perform step S112. The control device 600 of FIG. 7 may further comprise a number of optional functional modules, such as any of a retrieve module 720 configured to perform step S104, an aggregate module 730 configured to perform step S106, and a construct module 740 configured to perform step S108. In general terms, each functional module 710:760 may in one embodiment be implemented only in hardware and in another embodiment with the help of software, i.e., the latter embodiment having computer program instructions stored on the storage medium 630 which when run on the processing circuitry makes the control device 600 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 710:760 may be implemented by the processing circuitry 610, possibly in cooperation with the communications interface 620 and/or the storage medium 630. The processing circuitry 610 may thus be configured to fetch instructions as provided by a functional module 710:760 from the storage medium 630 and to execute these instructions, thereby performing any steps as disclosed herein.

A first portion of the instructions performed by the control device 600 may be executed in a first device, and a second portion of the of the instructions performed by the control device 600 may be executed in a second device. The embodiments disclosed herein are not limited to any particular number of devices on which the instructions performed by the control device 600 may be executed. Hence, the methods according to the embodiments disclosed herein are suitable to be performed by a control device 600 residing in a cloud computational environment. Therefore, although a single processing circuitry 610 is illustrated in FIG. 6, the processing circuitry 610 may be distributed among a plurality of devices, or nodes. The same applies to the functional modules 710:760 of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 610 and thereto operatively coupled entities and devices, such as the communications interface 620 and the storage medium 630, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept as defined by the appended patent claims.

1-25. (canceled)

26. A control device for ergonomic based reconfiguration of a virtual input device, the control device comprising processing circuitry, the processing circuitry being configured to cause the control device to:
obtain information of posture and/or movement of a user from a sensor whilst the user is interacting with the virtual input device in a virtual environment;
determine whether or not the posture and/or movement of the user satisfies an ergonomic criterion by comparing the posture and/or movement of the user to reference ergonomic data; and
reconfigure, when the posture and/or movement of the user fails to satisfy the ergonomic criterion, at least one setting of the virtual input device as a function of the posture and/or movement of the user and the reference ergonomic data to suggest to the user to change the posture and/or movement to be closer to satisfying the ergonomic criterion.

27. The control device according to claim 26, wherein the posture and/or movement of the user is represented by a user model defining a digital twin of the user, and wherein the digital twin is compared to the reference ergonomic data when determining whether or not the posture and/or movement of the user satisfies the ergonomic criterion.

28. The control device according to claim 27, wherein the digital twin represents any of: arms, hands, legs, feet, neck, head and torso of the user, or any combination thereof, with relative dimensions extracted from a digital representation of the user.

29. The control device according to claim 26, wherein the threshold value is dependent on relative dimensions of arms, hands, head and/or torso of the user as derived from a digital representation of the user.

30. The control device according to claim 26, wherein the reference ergonomic data represents postures and/or movements to be used by the user, wherein the posture and/or movement of the user fails to satisfy the ergonomic criterion when the posture and/or movement of the user deviate more than a first threshold value from the reference ergonomic data, and whereby the user is suggested to change the posture and/or movement to be closer to the reference ergonomic data.

31. The control device according to claim 26, wherein the reference ergonomic data represents postures and/or movements to be avoided by the user, wherein the posture and/or movement of the user fails to satisfy the ergonomic criterion when the posture and/or movement of the user deviate less than a second threshold value from the reference ergonomic data, and whereby the user is suggested to change the posture and/or movement to be further away from the reference ergonomic data.

32. The control device according to claim 26, wherein the processing circuitry further is configured to cause the control device to:
retrieve historical data representing previous postures and/or movements of the user, and wherein determining whether or not the posture and/or movement of the user satisfies the ergonomic criterion further is a function of the historical data.

33. The control device according to claim 26, wherein the processing circuitry further is configured to cause the control device to:
aggregate tracked posture and/or movement of the user over time; and
construct a user model from the tracked posture and/or movement of the user.

34. The control device according to claim 26, wherein the posture and/or movement of the user is tracked by at least one sensor configured to record sensor data representing a digital representation of the user, and wherein the digital representation of the user is analysed to track the posture and/or movement of the user in relation to the user input device in the virtual environment.

35. The control device according to claim 34, wherein the digital representation of the user pertains to at least one of: hand position and/or movement of the user, arm position and/or movement of the user, head position and/or movement of the user, neck position and/or movement of the user, and torso position and/or movement of the user.

36. The control device according to claim 26, wherein reconfiguring the at least one setting of the virtual input device is constrained by at least one property of a physical environment in which the virtual input device is deployed.

37. The control device according to claim 36, wherein the constraints are derived by the control device from information received by the control device of the physical environment.

38. The control device according to claim 26, wherein the at least one setting pertains to layout of buttons and/or keys on the virtual input device, and wherein the at least one setting is reconfigured by the layout of the buttons and/or keys being changed on the virtual input device.

39. The control device according to claim 26, wherein the at least one setting pertains to size and/or shape of buttons and/or keys on the virtual input device, and wherein the at least one setting is reconfigured by the size and/or shape of the buttons and/or keys being changed on the virtual input device.

40. The control device according to claim 26, wherein the at least one setting pertains to size and/or shape of the virtual input device, and wherein the at least one setting is reconfigured by the size and/or shape of the virtual input device being changed.

41. The control device according to claim 26, wherein the at least one setting pertains to spatial location of the virtual input device, and wherein the at least one setting is reconfigured by the spatial location of the virtual input device being changed.

42. The control device according to claim 26, wherein the at least one setting of the virtual input device is stepwise reconfigured from an initial setting to a final setting via at least one intermediate setting.

43. The control device according to claim 26, wherein the virtual input device is any of: a virtual keyboard, a virtual computer mouse, a virtual remote controller, a virtual gaming controller.

44. The control device according to claim 26, wherein the virtual environment is an extended reality (XR) virtual environment.

45. The control device according to claim 26, wherein the virtual environment is either an augmented reality (AR) virtual environment, a virtual reality (VR) virtual environment, or a mixed reality (MR) virtual environment.

46. The control device according to claim 26, wherein the control device is part of, or integrated with, a communication device.

47. A system, comprising a control device according to claim 26, and a user interface device, wherein the user interface device comprises a projection module for making the virtual input device visible on a surface, and the sensor for sensing user interaction of the user with the virtual input device.

48. A method for ergonomic based reconfiguration of a virtual input device, the method being performed by a control device, the method comprising:
obtaining information of posture and/or movement of a user from a sensor whilst the user is interacting with the virtual input device in a virtual environment;
determining whether or not the posture and/or movement of the user satisfies an ergonomic criterion by comparing the posture and/or movement of the user to reference ergonomic data; and
reconfiguring, when the posture and/or movement of the user fails to satisfy the ergonomic criterion, at least one setting of the virtual input device as a function of the posture and/or movement of the user and the reference ergonomic data to suggest to the user to change the posture and/or movement to be closer to satisfying the ergonomic criterion.
